(19) United States
(12) Patent Application Publication
(10) Pub. No.: US 2016/0151708 A1
(43) Pub. Date: Jun. 2, 2016

(54) Interactive Multi-Party Game

(71) Applicants: Andrew D. Ausonio, Monterey, CA (US); Andrew P. Ausonio, Monterey, CA (US)

(72) Inventors: Andrew D. Ausonio, Monterey, CA (US); Andrew P. Ausonio, Monterey, CA (US)

(21) Appl. No.: 14/558,651

(22) Filed: Dec. 2, 2014

(51) Int. Cl. A63F 13/31; A63F 13/45

(52) U.S. Cl. CPC A63F 13/31; A63F 13/45

(57) ABSTRACT

Disclosed herein is an interactive digital game and a gaming tool. The gaming includes the steps of each player being assigned a gaming tool; each player's gaming tool being assigned two parameters, a life force and an energy weapon force; a first player casting a spell on another player and appropriately incrementing, positively or negatively, the first player's energy weapon force; another player receiving the spell cast by the first player and appropriately incrementing, positively or negatively, the receiving player's life force; another player casting a spell on one of the players and appropriately incrementing, positively or negatively, the casting player's energy weapon force; the receiving player appropriately incrementing, positively or negatively, that player's life force; the players trading casting and receiving spells until only one player has life force and all other players' life force is extinguished; and the player with remaining life force being declared the winner.

### BACKGROUND OF THE INVENTION

1. Field of the Invention

This invention relates to the field of interactive electronic games. More particularly, the interactive electronic game herein, relates to such games having a basis in magic play including the casting of spells, the holding of effects and the recovery from spell casting.

2. Background

The popularity of books, stories and video games having to do with magic and fantasy in general has increased exponentially since the creation of the Harry Potter book series and other fantasy books. Since the release of the first Harry Potter book, in 1997, not only have the Harry Potter books gained in popularity, but the entire genre of fantasy and magic books and related activities has grown world-wide. According to Wikipedia, the Harry Potter books have sold over 450 million copies. The books have set sales records as the fastest selling books in history, including “tie-in” merchandising; Wikipedia estimates that the brand, Harry Potter, is worth over $15 Billion.

As expected, the success of Harry Potter has inspired not only Harry Potter-type entertainment, but has increased the public interest in the genre of fantasy and magic. Of course, it is commonly known and well-recognized that the films about Harry Potter have proved widely successful. In addition, there have developed video games. In fact, there are at least 11 video that have been created as a direct result and which are based solely or in part on the Harry Potter books. Virtually all of these video games involve occurrences around Hogswart and at least one scene from one of the movies. Very often the video game follows a theme from the book or movie attempts to remain true to the spirit and intent of the movie or both upon which it is based.

In some ways, a game about fantasy when restricted to a previously written book or movie, may limit the creativeness of the game itself. While the Harry Potter books are a terrific success, basing an entire game around the books may prove tiresome and counter-productive. Instead the claimed game herein bases its game parameters on the principles of magic and fantasy, which have been around far longer than the Harry Potter books.

The claimed game disclosed herein is based upon the ancient art of dueling, while using creative spells and defenses. The game is not limited to Harry Potter books and needs not be true to any particular previously written theme or topic, but rather leaves the players to create the game based upon the input of their fellow contestants and the game flow itself.

### SUMMARY OF THE INVENTION

Applicant has disclosed herein a unique interactive multiparty electronic game. The game herein is simple to understand and can be played using a special gaming tool or by using an “app” on a smart phone. The game includes the steps of assigning each player a life force and a weapon energy force. A player's life force is incrementally decreased each time the player is struck by a spell cast by another player. Additionally, each time a player casts a spell, that player's weapon force is incrementally decreased. Play continues until each player's life force goes to zero and that player is eliminated from the game. The game ends when only one player has life force remaining and is declared the winner.

The game includes the use of a gaming tool. The gaming tool includes the ability to send a signal to an opposing player, which defines casting a spell on that player. Additionally, the gaming tool includes an indicator member for displaying a player's total life force and total energy weapon force. The indicator member also accurately displays incremental changes in a player's life force and energy weapon force. When a player's life force is extinguished, by default that player's energy weapon force also goes to zero and no further spells can be cast by that player.

In an exemplary embodiment, the indicator member is lighted and clearly visible even in the dark. This facilitates multi-party interactive games at night or in dimly lighted areas.

A variety of different spells may be cast on opposing players. Each spell does damage to the life force according to the game rules. Each spell can be overcome, either by time or by using a cure. The gaming tool is provided with both spells and cures. As with casting a spell, applying a cure also decreases weapon strength incrementally and costs the player a turn. However, applying the correct cure, improves a player's ability to compete and make his life force stronger.

TABLE I
SPELLS

| Spell | Damage | Energy Cost | Effect |
|---|---|---|---|
| Frolith | 5 | 4 | Burn |
| Aquina | 5 | 3 | Wet |
| Ekoroth | 8 | 3 | none |
| Airion | 5 | 3 | Sniper |
| Suklion | 0 | 5 | Drain |
| Kano | 10 | 5 | none |
| Zat | 12 | 7 | conduction |
| Disonan | 10 | 8 | Disable |
| Tiron | 25 | 15 | none |
| Protinion | 0 | 8 | Protection |
| Helicot | 0 | 10 | heals |

The above Table 1 is a sample listing of the spells, weapon energy force cost and spell effects. In a first exemplary embodiment of the disclosed interactive game, spells are assigned. The assignment includes an assignment of damage, weapon energy force used and the effect caused on the opponent.

In another exemplary embodiment, the players choose spells and cures and work out the details of values and costs. For example, one method of play includes negatively increments the player's weapon energy force at 25% of the damage inflicted on the opponent. Thus, if the damage done is 8, then the weapon energy force would be 2. Similar details, such as total beginning life force, total weapon force are decided among the players prior to the start of the game.

In an exemplary embodiment, there are more than 2 players. For example 5 or 10 or more players may continue the game at any one time. In any case, two players are required.

The game requires that players face one another and not merely a video screen. The claimed game herein is truly interactive and requires players to socialize with each other and not merely a non-human video screen.

In another exemplary embodiment, each of the commands is voice activated.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is a schematic representation of the gaming tool in accordance with the disclosure herein.

FIG. 2 is another schematic representation, this one of the life force and weapon energy force displays of Player 1 in accordance with the disclosure herein.

FIG. 3 is another schematic representation, this one of the life force and weapon energy force displays of Player 2 in accordance with the disclosure herein.

FIG. 4 is another schematic representation, this one of the life force and weapon energy force displays of Player N, after the game, in accordance with the disclosure herein, has started.

FIG. 5 is another schematic representation, this one is a side by side comparison of the life force and weapon energy force displays of Player N and N x, after the game, in accordance with the disclosure herein, has started.

FIG. 6 is another exemplary embodiment, in schematic, of the gaming tool in accordance with the disclosure herein.

FIG. 7 is a schematic circuit diagram of the electronics of the gaming tool in accordance with the disclosure herein.

### DETAILED DESCRIPTION OF THE DISCLOSED ELECTRONIC GAME AND GAMING TOOL

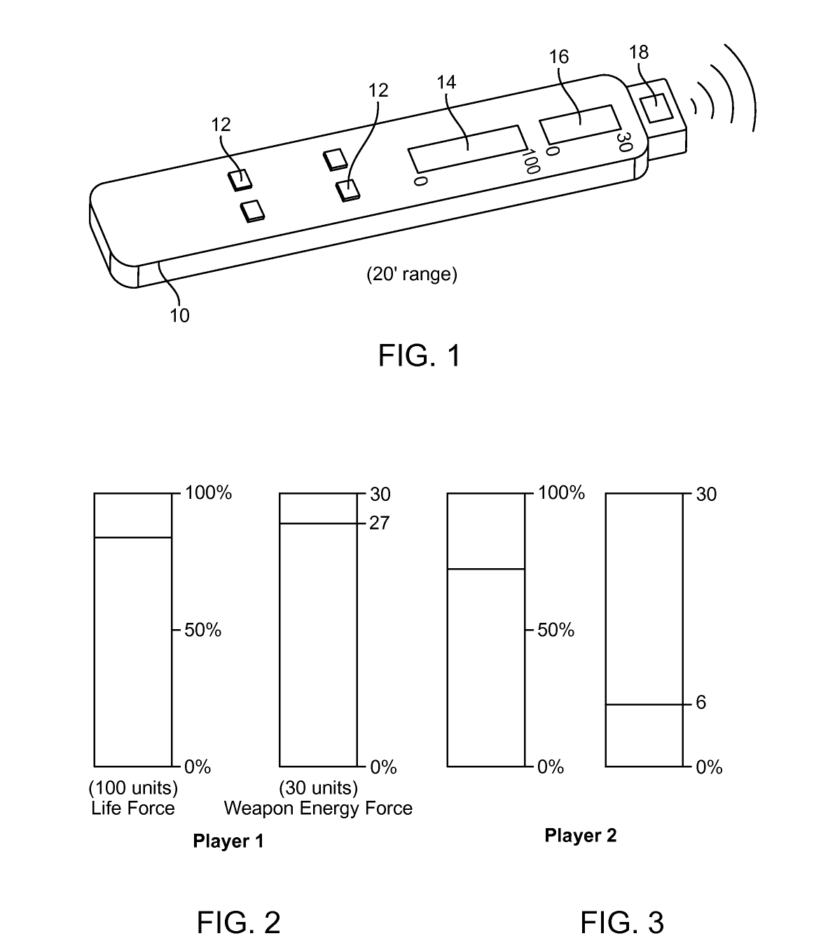

The invention will now be described with respect to FIGS. 1-5, which illustrate an exemplary embodiment of the disclosure herein. Particularly, FIG. 1 illustrates a gaming tool 10, disclosed by applicant herein and shown generally by the numeral 10. The gaming tool 10 disclosed herein is a dedicated hardware tool, which takes the form of an electronic device.

In a first exemplary embodiment, the gaming tool 10 of FIG. 1 comprises dedicated hardware defining a controller. in this exemplary embodiment, the gaming tool 10 is suitable only for purposes of playing the disclosed game herein. In this embodiment, the gaming tool 10 is suitable only for game play and may not be used as a phone, other game controller, TV controller or for any other electronic purpose. In an exemplary embodiment, the gaming tool is in the form of a wand.

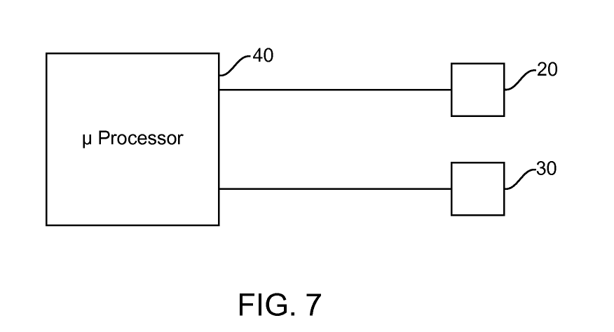

As shown schematically in FIG. 7, the gaming tool 10 includes a transmitter 20 and a receiver 30. The gaming tool 10 transmits a spell at a precise frequency. That precise frequency is received by the opponent's gaming tool and recognized by the opponent's gaming tool as the particular spell being sent. That particular spell has the assigned predetermined level of damage and a defined type of damage as set by the rules of the game prior to the initiation of the game.

The gaming tool 10 includes a microprocessor 40 (FIG. 7), which is connected to both the transmitter 20 and the receiver 30. The player selects a spell to be cast upon an opponent. When the spell is selected, the microprocessor 40 sends the signal associated with the particular spell to the transmitter 20, which then transmits the signal to the receiver of the opponent's gaming tool. The opponent's microprocessor decodes the signal for the particular spell and registers the effects on the player's life force and weapon energy force. The opponent's microprocessor also records the time of receiving the spell. The microprocessor 40 of the sending player registers and records the loss of weapon energy force from the sender of the spells as well. The weapon energy force is appropriately decremented.

The game continues with each player with the players trading spells and using cures until only one player is left having a measurable life force. That player is then declared the winner.

With particular reference to FIG. 1, there is shown the dedicated gaming tool 10. The gaming tool 10 is designed for use with the specific game disclosed herein and for no other use. The gaming tool 10 includes various control buttons 12. Each control button 12 is programmable. Thus, all the buttons 12 are identical, only the programming is changed.

In an exemplary embodiment shown in FIG. 1, there is a button 12 reserved for casting a spell. Another button 12 is reserved for self-administering a cure. Still another button 12 causes the life force value to flash on the display screen. Pressing that same button 12 causes the player's weapon energy force to be displayed. Another button 12 is reserved for switching from one opponent to another. Once the player selects a certain opponent, the player can then display the life force and weapon energy force values on the display screen of the gaming tool 10.

The gaming tool 10 includes a dual bar graph, which includes displays 14 and 16. The bar graph display 14 shows the player's life force value. The bar graph 16 displays the player's weapon energy force.

The gaming tool 10 includes a display screen 18. As noted above the display screen 18 is multi-purpose. By pressing and re-pressing the button 12 associated with the display screen, the screen will scroll through the life force and weapon energy force of the player or any of the opponents, both active and de-active in the present game. Repeated pressing of the button 12 connected with the display screen 18 continues the scrolling process. At the end of the game, the microprocessor clears the players in the game and new players are entered so that the microprocessor can register record and then cause to be displayed each player and his opponents.

In the exemplary embodiment of FIG. 1, the gaming tool 10 has a range of 20′. In other exemplary embodiments, it is contemplated that the gaming tool 10 will have a range of 10′ to 15′ and in other embodiments a range of more than 20′.

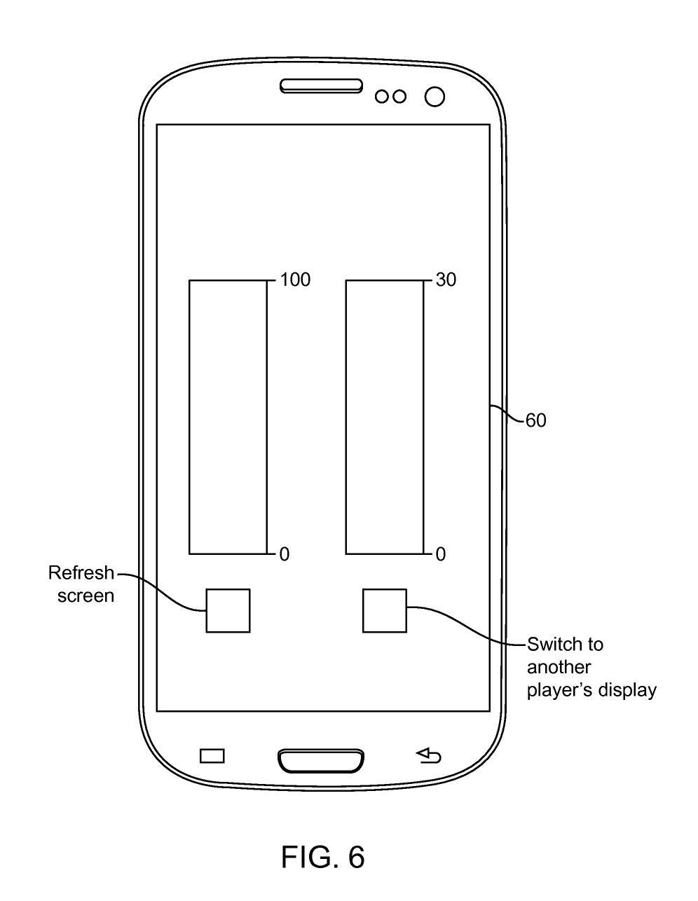

With particular reference to FIG. 6, there is shown another exemplary embodiment of a gaming tool 60. In this embodiment, the player uses his smart phone. An application from the web is downloaded in the usual fashion and loaded onto the player's smart phone, which then, when the application is active, defines gaming tool 60. The application turns the smart phone display into the game displays previously describe. Soft keys appear on the phone and are the full equivalent of the keys noted above.

It is contemplated that an I phone, Samsung Galaxy or Note or their replacements or similar smart phone are all usable in the game disclosed herein and can be readily adapted as a gaming tool 10.

FIGS. 2 and 3 illustrate displays found on the gaming tools 10 and 60 for both life force and weapon energy force. Typically, the life force graphs for starting the game equals 100. The numerical value of 100 represents the life force in its fully charged state. Like the weapon energy force starts the game at 30. Of course, it is within the spirit and scope of the disclosure herein that the numerical values above are arbitrary and that as such these values may change to suit the game at hand. The values are easily programmed into the microprocessor and may be change to suit the game and the players associated therein.

In a two-person game, FIG. 2 represents the graphical display of the life force and weapon energy force of Player 1. Similarly, in a two-person game, FIG. 3 represents the graphical display of the life force and weapon energy force of Player 2. As will be appreciated, each player's gaming tool 10 includes such a display and while only two displays are shown, it is within the spirit and scope of the disclosure that many such displays are present in the game being played, particularly, each player's gaming tool 10 will have both displays.

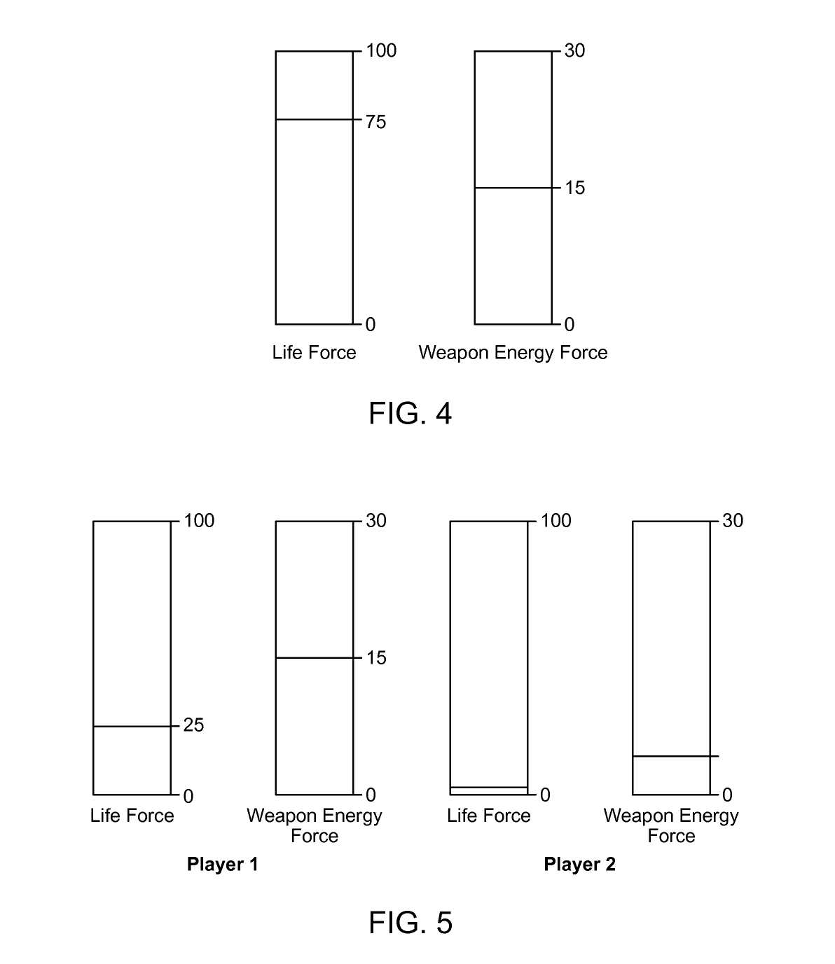

FIG. 4 illustrates the life force and weapon energy force of Player 1 after the game has commenced. As shown Player 1 has used half his weapon energy force and the weapon energy force for Player 1 is now 15 and Player 1's life force is at 75.

Game Play

FIG. 5 illustrates a winning player sequence. Player 1 has a life force of 25 and weapon energy force of 15. On the other hand, Player 2's life force has gone completely to zero and he has been eliminated from the game.

In the exemplary embodiment depicted, the following applies:
Burn: —Causes 1 unit of damage for 5 seconds to the target.
2. Wet—If the target has “Wet” effect; it will cause double the damage when hit with any spell having a “Conduction” effect. Additionally, if the target is in possession of the “Wet” effect, there is no damage from a spell having the “burn” effect and the target simply loses his “Wet” effect.
3. Sniper—is an effect, which increases the range of casting a spell; i.e. player can hit target from further away than without this effect.
4. Drain—is a spell which negatively increments by 10, the target's weapon energy force.
5. Conduction—is a spell, which causes a reduction of 5 in life force; if the target is in possession of the “Wet” effect, this spell does 2 times the amount of damage.
6. Disable—is a spell, upon receiving this spell; the target cannot use spells/heal/regain energy for 30 seconds.
7. Protection—is an effect, which prevents the target holding the effect from receiving a spell of any kind.
8. Heal—is an effect, which raises life force by an amount equal to the cost of weapon energy force. i.e. in order to gain a value of 10 in life force, the player spends 10 in weapon energy force.

It will be appreciated that each of the depressions on the gaming tool defines an electronic command to the micro-processor. It will further be appreciated that each of these commands in another exemplary embodiment are accomplished through the use of voice instead of the depression of a button.

While the foregoing detailed description has described several embodiments of the interactive electronic game in accordance with this disclosure, it is to be understood that the above description is illustrative only and not limiting of the disclosed invention. Particularly, the rules of the game may vary depending upon player preference and skill levels. Additional, other variations are noted above and will be readily understood by those skilled in the art of creating games as well as those who play games on a regular basis. It will be appreciated that the embodiments discussed above and the virtually infinite embodiments that are not mentioned could easily be within the scope and spirit of this invention. Thus, the invention is to be limited only by the claims as set forth below.

What is claimed is:

1. A game for play amongst at least two players, the game comprising the steps of:
each player being assigned a gaming tool;
each player's gaming tool being assigned two parameters, a life force and an energy weapon force;
a first player casting a spell on another player and appropriately incrementing, positively or negatively, the first player's energy weapon force;
another player receiving the spell cast by the first player and appropriately incrementing, positively or negatively, the receiving player's life force;
another player casting a spell on one of the players and appropriately incrementing, positively or negatively, the casting player's energy weapon force;
the receiving player appropriately incrementing, positively or negatively, that player's life force;
the players trading casting and receiving spells until only one player has life force and all other players' life force is extinguished; and
the player with remaining life force being declared the winner.

2. A multiple player game as set forth in claim 1, which includes the step of:
assigning predetermined number of spells for each gaming tool, each spell having specific characteristics and function.

3. A multiple player game as set forth in claim 2, which includes the step of:
assigning each spell a specific negative incremental value and a specific antidote.

4. A multiple player game as set forth in claim 1, which includes the step of:
assigning a cost to casting a spell.

5. A multiple player game as set forth in claim 4, which includes the step of:
assigning the negative increment of 25% of the life force negatively incremented on the receiving player to the energy weapon force.

6. A multiple player game as set forth in claim 1, wherein the range of the gaming tool is predetermined.

7. A multiple player game as set forth in claim 6, wherein the range of the gaming tool is 20 feet.

8. A multiple player game as set forth in claim 6, wherein each spell has a specific predetermined effect on the receiving player.

9. A multiple player game as set forth in claim 1, which includes the step of recovery after receiving a spell.

10. A multiple player game as set forth in claim 9, which includes the step of recovery after receiving a spell.

11. A multiple player game as set forth in claim 10, which includes the step of recovering 5 units of life force after every minute of play.

12. A multiple player game as set forth in claim 10, which includes the step of recovering 5 units of weapon energy force after every 2 minutes of play.

13. A multiple player game as set forth in claim 1, which includes the step of limiting life force negative increments to a predetermined value within 1 minute of play.

14. A multiple player game as set forth in claim 13, wherein the predetermined value is 100 units of life force.

15. A game for play amongst at least two players, the game comprising the steps of:
each player being assigned a gaming tool;
each player's gaming tool being assigned two parameters, a life force and an energy weapon force;
a first player casting a spell on a second player and appropriately incrementing, positively or negatively, the first player's energy weapon force;
the second player receiving the spell cast by the first player and appropriately incrementing, positively or negatively, the second player's life force;
a second player casting a spell on another player and appropriately incrementing, positively or negatively, the second player's energy weapon force;
a first player receiving the spell cast by the first player and appropriately incrementing, positively or negatively, the first player's life force;
the player's trading casting and receiving spells until one player's life for is extinguished; and
the player with remaining life force being declared the winner.

16. A gaming tool comprising
each player being assigned a gaming tool;
the gaming tool being assigned two parameters, a life force and an energy weapon force;
each gaming tool being capable of casting spells and appropriately incrementing the energy force;
each gaming tool being capable of receiving spells and appropriately incrementing the life force.
